(19) United States
(12) Patent Application Publication
(10) Pub. No.: US 2006/0210860 A1
(43) Pub. Date: Sep. 21, 2006

(54) Separator for fuel cell

(75) Inventors: Tsuyoshi Inagaki, Shizuoka (JP); Atsushi Omura, Shizuoka (JP); Hideto Nakano, Shizuoka (JP); Kouji Nagai, Shizuoka (JP); Tetsuo Ohinata, Shizuoka (JP)

Correspondence Address: NIXON & VANDERHYE, PC, 901 NORTH GLEBE ROAD, 11TH FLOOR, ARLINGTON, VA, 22203, US

(73) Assignee: Nichias Corporation, Tokyo (JP)

(21) Appl. No.: 11/376,563

(22) Filed: Mar. 16, 2006

(30) Foreign Application Priority Data
Mar. 17, 2005 (JP) P.2005-077134

(51) Int. Cl. H01M 8/02; H01B 1/24

(52) U.S. Cl. 429/34; 252/511

(57) ABSTRACT

A separator for fuel cells, comprising: a conductive filler comprising expanded graphite; a binder; and carbon fibers, wherein the separator has a deflection in flexure at break of 1 mm or larger, a modulus in flexure of 10 GPa or lower, and a flexural strength of 30 MPa or higher, each as examined at 100° C.

### FIELD OF THE INVENTION

The present invention relates to a separator for fuel cells. More particularly, the invention relates to a separator for fuel cells which, even when reduced in thickness, is excellent in toughness and impact resistance.

### BACKGROUND OF THE INVENTION

The demand for fuel cells, which directly convert the chemical energy possessed by a fuel into electrical energy, is growing in recent years. In general, a fuel cell has a constitution comprising a stack of many unit cells each comprising electrode plates, an electrolyte-containing matrix sandwiched therebetween, and a separator disposed on an outer side of these electrode plates.

FIG. 1 is a slant view illustrating a fuel-cell separator 5 as one example of general separators for fuel cells. This separator 5 is constituted of a flat plate part 6 and partition walls 7 protruding from each side thereof at a given interval. In fabricated a fuel cell, many such fuel-cell separators 5 are stacked in the direction of protrusion of the partition walls 7 (top-bottom direction in the figure). As a result of this stacking, channels 8 are formed each by a pair of adjacent partition walls 7. Various fluids are passed through these channels 8.

Usually, a fuel is supplied to one side of each fuel-cell separator 5, while a gaseous oxidizing agent or the like is supplied to the other side. The fuel-cell separator 5 is hence required to have excellent gas impermeability so as to prevent the two ingredients from mixing. Since unit cells are stacked, the separator is further required to have high electrical conductivity, small weight, low cost, etc. Furthermore, the separator is required to have a strength which enables the separator to withstand the pressure to be applied thereto when the stack is clamped for the purposes of sealing up a gas and reducing contact resistance.

Known fuel-cell separators heretofore in use include ones produced by forming a plate material from high-density graphite or graphite impregnated with a thermosetting resin and forming grooves, e.g., as those shown in FIG. 1, therein by cutting (see, for example, patent document 1).

Also known is a separator for fuel cells which is obtained not through machining but by molding a conductive resin composition comprising a thermosetting resin and an artificial graphite into a shape, e.g., as shown in FIG. 1 (see, for example, patent document 2).

Patent Document 1: JP-A-59-53167

Patent Document 2: JP-A-60-37670

With the recent trend toward size reduction in fuel cells, the thicknesses of fuel-cell separators also are becoming smaller. Separators for fuel cells have come to be strongly required to be excellent in toughness and impact resistance even when they have a reduced thickness.

However, the graphite plate impregnated with a thermoset resin has a drawback that the plate having a reduced thickness is apt to break during cutting. Furthermore, the fuel-cell separator obtained by molding a conductive resin composition has a drawback that since the composition should contain an artificial graphite in a large amount so as to attain necessary conductivity and hence has a relatively reduced resin amount, the separator is brittle when it has a reduced thickness. The fuel-cell separator hence has problems that it is apt to break upon assembling a fuel cell and that the separator has poor reliability and cannot be used as it is in fuel cells to be mounted on vehicles or in portable fuel cells; such fuel cells are supposed to be used in severe environments.

### SUMMARY OF THE INVENTION

The invention has been achieved under the circumstances described above.

An object of the invention is to provide a separator for fuel cells which is excellent in toughness and impact resistance even when it has a reduced thickness.

Other objects and effects of the invention will become apparent from the following description.

That a separator for fuel cells is excellent in toughness and impact resistance means that the separator has a high flexural strength, a low modulus, and a large deflection at break. In the case where a separator for fuel cells has a high flexural strength but has a high modulus and a small deflection at break, it breaks when deformed slightly. The thickness fluctuations, warpage, etc. of separators for fuel cells are remedied upon assembling a fuel cell. However, fuel-cell separators having a high modulus and a small displacement amount at break suffer breakage. Furthermore, in applications supposed to involve vibrations, as in fuel cells for vehicles or portable fuel cells, the fuel-cell separators may suffer positional shifting and repeatedly receive a stress due to vibrations, which leads to separator breakage. Consequently, for providing a fuel-cell separator excellent in toughness and impact resistance, it is necessary to impart a high flexural strength, a low modulus, and a large displacement amount at break.

The inventors made extensive investigations on values of those properties. As a result, it has been found that when a fuel-cell separator is constituted so as to have a modulus in flexure of 10 GPa or lower, a displacement amount at break of 1 mm or larger, and a flexural strength of 30 MPa or higher in a bending test at 100° C, then the separator is excellent in toughness and impact resistance.

Namely, the invention provides the following separators for fuel cells in order to accomplish the objects.

(1) A separator for fuel cells, comprising:

a conductive filler comprising expanded graphite;

a binder; and

carbon fibers,

wherein the separator has a deflection in flexure at break of 1 mm or larger, a modulus in flexure of 10 GPa or lower, and a flexural strength of 30 MPa or higher, each as examined at 100° C.

(2) The separator for fuel cells as described in item (1) above, wherein the conductive filler further comprises an artificial graphite in a proportion of up to 100 parts by weight per 100 parts by weight of the expanded graphite.

(3) The separator for fuel cells as described in item (2) above, wherein the artificial graphite has an average particle diameter which is not larger than 75% of the thickness of the thinnest part of the separator for fuel cells.

(4) The separator for fuel cells as described in any one of items (1) to (3) above, wherein the binder comprises at least one member selected from the group consisting of an epoxy resin, a polyimide resin, and a functional-group-containing acrylonitrile/butadiene rubber.

(5) The separator for fuel cells as described in item (4) above, wherein the binder comprises up to 50 parts by weight of a functional-group-containing acrylonitrile/butadiene rubber per 100 parts by weight of an epoxy resin.

(6) The separator for fuel cells as described in any one of items (1) to (5) above, wherein the content of the conductive filler is 50 to 70% by weight, the content of the binder is 20 to 40% by weight, and the content of the carbon fibers is 5 to 10% by weight.

The separator for fuel cells of the invention has a deflection in flexure and a flexural strength which are not lower than respective specific values and further has a modulus in flexure not higher than a specific value. Because of this, the separator, even when molded in a small thickness, is excellent in toughness and impact resistance and does not break upon assembling a fuel cell. The separator further has high reliability.

### BRIEF DESCRIPTION OF THE DRAWINGS

FIG. 1 is a slant view illustrating one example of the fuel-cell separator of the invention and fuel-cell separators heretofore in use.

FIG. 2 is a diagrammatic view showing a method of measuring a passing-through direction resistance.

The reference numerals used in the drawings denote the followings, respectively.

5: Separator for fuel cell

6: Flat plate part

7: Partition wall

8: Channel

### DETAILED DESCRIPTION OF THE INVENTION

The invention will be explained below in detail.

The conductive filler in the invention comprises expanded graphite as an essential ingredient. As is demonstrated by the Examples given below, when a conductive filler not containing expanded graphite is used, the fuel-cell separator to be provided by the invention, i.e., a separator which is excellent in toughness and impact resistance even when thin, cannot be provided. In contrast, when a conductive filler comprising expanded graphite is used according to the invention, a separator excellent in impact resistance and fracture toughness can be provided.

Expanded graphite is obtained by treating flaky graphite with concentrated sulfuric acid or the like with heating. It has widened spaces between graphite crystal structure layers and is extremely bulky. Compared to spherical graphite, expanded graphite has a larger surface area and is composed of particles of a thinner platy shape. Because of this, expanded graphite readily forms conduction paths upon mixing with a resin to give a fuel-cell separator having high electrical conductivity. The expanded graphite to be used has a bulk density of preferably 0.3 g/cm³ or lower, more preferably 0.1 g/cm³ or lower, especially preferably 0.05 g/cm³ or lower. In the case where the expanded graphite has a high bulk density, particles of this expanded graphite are less apt to intertwine with one another and the strength and conductivity required of separators for fuel cells are not obtained. In addition, the impact resistance and fracture toughness which are intended to be attained by the invention are not obtained.

The conductive filler preferably consists of expanded graphite alone. However, it may comprise a combination of expanded graphite and another conductive material. The conductive material to be used in combination with expanded graphite preferably is an artificial graphite, which may be incorporated in an amount of up to 100 parts by weight per 100 parts by weight of the expanded graphite. In the case where the proportion of the artificial graphite exceeds 100 parts by weight, the conductivity required of separators for fuel cells is not obtained. The proportion of the artificial graphite is more preferably from 25 parts by weight to less than 100 parts by weight, still more preferably 40 to 70 parts by weight.

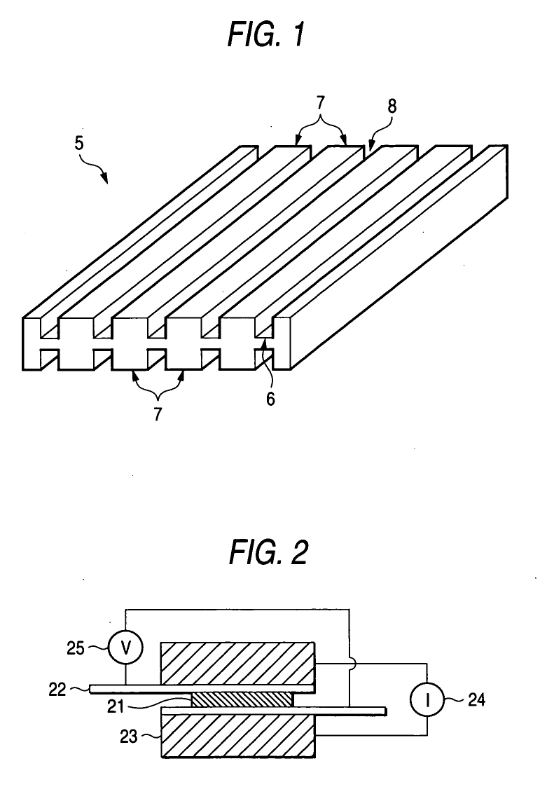

The artificial graphite desirably has an average particle diameter which is not larger than 75% of the thickness of the thinnest part of the fuel-cell separator to be obtained. The term “thinnest part” in the case of, e.g., the fuel-cell separator 5 shown in FIG. 1 means the thickness of the flat plate part 6. In the case where the artificial graphite has too large a particle diameter, there may be cases where the artificial graphite is partly exposed on the surface of the fuel-cell separator to cause an increase in contact resistance. When the thinnest part of the separator for fuel cells has a thickness of, for example, 0.5 mm, then the average particle diameter of the artificial graphite is desirably 125 μm or smaller, preferably 50 μm or smaller.

The conductive filler is preferably incorporated in such an amount as to account for 50 to 70% by weight of all ingredients. In the case where the amount of the conductive filler incorporated is smaller than 50% by weight, there is a tendency that satisfactory conductivity is not obtained. Conversely, amounts thereof exceeding 70% by weight tend to pose a problem concerning strength or molding operation. When these are taken into account, the amount of the conductive filler to be incorporated is more preferably 60 to 70% by weight.

The binder to be used can be either one resin material such as an epoxy resin or a polyimide resin or a mixture of two or more such resins. Further, a functional-group-containing nitrile/butadiene rubber that is reactive with an epoxy resin may be used in combination. When the properties required of fuel-cell separators, productivity, etc. are taken into account, an epoxy resin is preferably used. In the case where an improvement in heat resistance is further intended, it is preferred to further employ a polyimide resin in combination with the epoxy resin. In the case where impact resistance and fracture toughness are intended to be further enhanced, it is preferred to employ a functional-group-containing acrylonitrile/butadiene rubber in combination with the epoxy resin.

The term “epoxy resin” herein means to include both structures formed by the reaction of one or more polyfunctional epoxy compounds with a hardener and epoxy compound/hardener combinations which give such structures. Hereinafter, an epoxy compound which has not undergone such a reaction and a structure yielded by the reaction are often referred to as an epoxy resin precursor and an epoxy compound, respectively. The amount of an epoxy resin is equal to the weight of a cured epoxy resin obtained therefrom.

As the epoxy resin precursor can be used any of various known compounds. Examples thereof include bifunctional epoxy compounds such as the bisphenol A diglycidyl ether type., bisphenol F diglycidyl ether type, bisphenol S diglycidyl ether type, bisphenol AD diglycidyl ether type, and resorcinol diglycidyl ether type; polyfunctional epoxy compounds such as the phenolic novolak type and cresol novolak type; and linear aliphatic epoxy compounds such as epoxidized soybean oil, alicyclic epoxy compounds, heterocyclic epoxy compounds, glycidyl ester epoxy compounds, and glycidylamine epoxy compounds. However, epoxy resin precursors usable in the invention should not be construed as being limited to these examples. The epoxy equivalent, molecular weight, and the like of each of those compounds also are not particularly limited.

Those epoxy resin precursors react with a hardener to give cured epoxy resins. As the hardener also, various known compounds can be used. Examples thereof include aliphatic, alicyclic, and aromatic polyamines such as dimethylenetriamine, triethylenetetramine, tetraethylenepentamine, menthenediamine, and isophoronediamine and carbonates of these polyamines; acid anhydrides such as phthalic anhydride, methyltetrahydrophthalic anhydride, and trimellitic anhydride; polyphenols such as phenolic novolaks; polymercaptans; anionic polymerization catalysts such as tris(dimethylaminomethyl)phenol, imidazole, and ethylmethylimidazole; cationic polymerization catalysts such as BF₃ and complexes thereof; and latent hardeners which generate these compounds upon pyrolysis or photodecomposition. However, the hardener should not be construed as being limited to these examples. It is also possible to use two or more hardeners in combination.

Examples of usable hardening accelerators include primary and tertiary amines, hydrazide compounds, urea derivatives, imidazole compounds, amine compounds of azabicyclo compounds, organophosphorus compounds, and onium salts.

The term “polyimide” as used herein means to include all polymers having imide groups ((—CO—)₂N—) in the molecule. Examples thereof include thermoplastic polyimides such as poly(amide-imide)s and polyetherimides; and thermosetting polyimides such as bismaleimide-based polyimides, nadic acid-based polyimides, e.g., allylnadimide-based ones, and acetylene-based polyimides. It is preferred in the invention to use thermosetting polyimides because thermosetting polyimides have an advantage over thermoplastic polyimides and non-thermoplastic polyimides that they are easy to process. Thermosetting polyimides are highly satisfactory in high-temperature properties among various organic polymers and develop almost no voids or cracks through curing. Thermosetting polyimides are hence suitable for use as a component of the resin composition for use in the invention.

The proportion of an epoxy resin and that of a polyimide resin preferably are 5 to 95% by weight and 95 to 5% by weight, respectively. In the case where the proportion of either one of the resins is lower than 5% by weight, the advantage brought about by using these resins in combination is not marked. The ratio of the amount of an epoxy resin to that of a polyimide resin is more preferably from 95:5 to 30:70, still more preferably from 85:15 to 60:40.

The functional-group-containing acrylonitrile/butadiene rubber is intended to be reacted with the epoxy resin. Even when a general rubber such as, e.g., an acrylonitrile rubber, hydrogenated nitrile rubber, styrene/butadiene rubber, or ethylene/propylene rubber is mixed with the epoxy resin, the molded article obtained from the resultant composition has almost unimproved impact resistance because the rubber and the resin have poor compatibility. In contrast, when a functional-group-containing acrylonitrile/butadiene rubber is used, the functional groups undergo an addition polymerization reaction with the epoxy groups of the epoxy resin precursor to form a rubber-modified epoxy resin compound. This compound has a well balanced combination of the softness or flexibility of the rubber and the heat resistance and strength of the resin. Consequently, when this compound is used as a binder for fuel-cell separator production, a fuel-cell separator excellent in impact resistance and fracture toughness can be provided. Examples of the functional groups possessed by the acrylonitrile/butadiene rubber include carboxyl, amino, and vinyl groups, and the functional groups may be any of such groups. The functional groups may be located at the ends of the main chain or arranged randomly.

The proportion of the functional-group-containing acrylonitrile/butadiene rubber is preferably 50 parts by weight or smaller per 100 parts by weight of the epoxy resin. In the case where the proportion thereof exceeds 50 parts by weight, strength decreases due to the increased rubber proportion. The proportion of the functional-group-containing acrylonitrile/butadiene rubber is preferably from 10 parts by weight to less than 50 parts by weight, more preferably 20 to 40 parts by weight.

The binder is preferably incorporated in such an amount as to account for 20 to 40% by weight of all ingredients. In the case where the amount of the binder incorporated is smaller than 20% by weight, molding tends to be difficult because the material has reduced flowability. In addition, such a small binder amount tends to result in a lessened binder effect to pose a problem, for example, that the fuel-cell separator shows enhanced thickness recovery and a desired thickness is not obtained. Furthermore, there is a possibility that the reduced binder amount results in a decrease in strength, making it impossible to provide the fuel-cell separator having excellent impact resistance which is to be provided by the invention. Conversely, in the case where the amount of the binder exceeds 40% by weight, the content of the conductive filler becomes relatively low and this composition tends to give a molded article having reduced conductivity, which may make it unsuitable for use as a fuel-cell separator. When these points are taken into account, the amount of the binder is more preferably 25 to 35% by weight.

By incorporating carbon fillers, the strength and impact resistance of the separator for fuel cells can be further heightened. Examples of the carbon fibers include PAN-derived carbon fibers, pitch-derived carbon fibers, and rayon-derived carbon fibers. Such fibrous materials may be used alone or as a mixture of two or more thereof.

The shape of the carbon fibers is not particularly limited. It is, however, preferred to use carbon fibers having a fiber length of about 0.01 to 10 mm, especially 0.1 to 1 mm. In the case where carbon fibers having a fiber length exceeding 10 mm are used, difficulties may be encountered in molding because such fibers, even when some are broken and reduced into shorter fibers during mixing, may remain long. Furthermore, there is a tendency that a smooth surface is difficult to obtain. In the case where carbon fibers having a fiber length shorter than 0.01 mm are used, there is a tendency that a reinforcing effect is not expected because these fibers are broken into shorter fibers during mixing.

The carbon fibers may be incorporated in such an amount as to account for 5 to 10% by weight of all ingredients. In the case where the amount of the carbon fibers incorporated is smaller than 5% by weight, there is a tendency that satisfactory impact resistance is not obtained. In the case where the amount thereof exceeds 10% by weight, there is a tendency that conductivity is impaired and problems concerning molding operation arise due to reduced flowability. When these are taken into account, the amount of the carbon fibers to be incorporated is more preferably 7 to 9% by weight.

The conductive filler, binder, and carbon fibers can be mixed together by a known technique. For dry mixing, for example, use can be made of a planetary mixer, Henschel mixer, ball mill, or the like. For melt mixing can be used a pressure kneader, Banbury mixer, or the like. A solvent may be used for the mixing.

The mixture obtained is molded into a given shape, whereby the fuel-cell separator of the invention is obtained. This molding step can be conducted by a molding technique such as, e.g., injection molding, injection-compression molding, extrusion molding, or compression molding. When cost is taken into account, injection molding is preferred. The shape and structure of the fuel-cell separator are not limited. For example, the separator can have the shape shown in FIG. 1. Molding conditions are not limited and may be appropriately selected according to the composition and properties of the mixture obtained.

Since the fuel-cell separator of the invention is one obtained from the composition comprising the specific ingredients described above, it has a deflection in flexure at break of 1 mm or larger, a modulus in flexure of 10 GPa or lower, and a flexural strength of 30 MPa or higher when examined at 100° C. This separator hence is excellent in toughness and impact resistance.

### EXAMPLES

The invention will be illustrated in greater detail by reference to the following Examples and Comparative Examples, but the invention should not be construed as being limited thereto.

### Examples 1 to 4 and Comparative Examples 1 to 6

The conductive filler, binder, and carbon fibers shown below were used according to the formulations shown in Table 1 to produce samples through melt mixing by the method shown below. Each sample was subjected to (1) conductivity evaluation and (2) bending test shown below.

<Conductive Filler>

Expanded graphite (average particle diameter, about 400 to 800 μm)

Artificial graphite (average particle diameter, about 40 to 50 μm)

<Binder>

Epoxy resin (epoxy compound formed from a polyfunctional epoxy resin, a polyphenol, and imidazole)

Polyimide resin (bismaleimide-based polyimide)

Carboxyl-containing rubber (carboxyl group-containing acrylonitrile/butadiene rubber)

<Carbon Fibers>

Pitch-derived carbon fibers (fiber length, 0.37 mm; fiber diameter, 0.013 mm)

<Production Method>

Using a kneader, the binder melted by heating to a given temperature was kneaded together with the conductive filler and carbon fibers. The mixture thus obtained by kneading was preformed with a cold press. This perform was packed into a grooved mold coated with a release agent. Compression molding was conducted at a temperature of 150° C. and a pressure of 98 MPa. The molded article obtained had the shape shown in FIG. 1. This molded article was used as a sample to be subjected to the bending test. The sample had dimensions of 100 mm×100 mm×1-2 mm (thickness). A sheet having dimensions of 30 mm×30 mm×2 mm (thickness) was molded from the same mixture as a sample for conductivity evaluation.

(1) Conductivity Evaluation

Resistance in the passing-through direction was measured by the method shown in FIG. 2 to evaluate conductivity. A sample 21 was set between electrodes 23 through carbon papers 22. The electrical resistance was calculated from the current caused to flow through the electrodes (measured with an ammeter 24) while imposing a load of 1 MPa to the electrodes and from the voltage between the carbon papers (measured with a voltmeter 25). This value of electrical resistance was multiplied by the area of the sample to determine the passing-through direction resistivity. This value of passing-through direction resistance includes two contact resistance values for the contact of the sample 21 with each of the carbon papers 22 and the volume resistance value of the sample 21. The results obtained are shown in Table 1. The resistance is preferably 20 mΩ·cm² or lower, more preferably 15 mΩ·cm² or lower, from the standpoint of use as a fuel-cell separator.

(2) Bending Test

Flexural strength and modulus in flexure were determined through a three-point bending test conducted in a 100° C. atmosphere using “Autograph AG-100kND”, manufactured by Shimadzu Corp., in accordance with JIS K7171. Namely, a test piece was held on supports apart from each other at a distance of 40 mm, and a load was imposed on the center of the sample. The load and the deflection in flexure were measured until the sample broke. Furthermore, a load-deflection curve was drawn and the modulus in flexure was calculated from a slope of the load-deflection curve. The test piece was one cut out of the sample described above so as to have a width of 10 mm, length of 50 mm, and thickness of 1 mm. Acceptable values of flexural strength, modulus in flexure, and deflection in flexure at break are 30 MPa or higher, 10 GPa or lower, and 1 mm or larger, respectively.

The formulations and test results of the Examples and Comparative Examples are shown in Table 1. The samples of Examples 1 and 2, which employed a combination of expanded graphite and an artificial graphite as a conductive filler, showed excellent conductivity and satisfied the flexural properties specified in the invention. These molded articles were highly suitable for use as fuel-cell separators. The samples of Examples 3 and 4, which employed a binder including a rubber, had a reduced modulus, an increased deflection at break, and enhanced toughness although slightly reduced in strength. It is, however, noted that incorporation of too large an amount of the rubber as in Comparative Example 6 results in a considerable decrease in strength because properties of the rubber have greater influences.

The sample of Comparative Example 1, which employed a conductive filler consisting of an artificial graphite only, had an exceedingly high resistance and was unusable as a fuel-cell separator, although satisfactory in the desired strength, modulus, and deflection at break. The sample of Comparative Example 2, which employed a combination of expanded graphite and an artificial graphite, had a low strength and a small deflection at break and was hence apt to break although satisfactory in resistance. This is because the amount of the conductive filler incorporated was too large, i.e., the binder amount was too small. The sample of Comparative Example 3, which conversely had too large a binder amount, had a high resistance although high in strength. This molded article also was unusable as a fuel-cell separator.

The sample of Comparative Example 4, which had a small carbon fiber amount, had an insufficient strength and was apt to break because the reinforcing effect of the carbon fibers was low. The sample of Comparative Example 5, which conversely had too large a carbon fiber amount, had a high resistance although high in strength. This molded article was hence unusable as a fuel-cell separator.

TABLE 1

| | | Comp. | Comp. | Comp. | Comp. | Comp. | Comp. | Exam- | Exam- | Exam- | Exam- |
|---|---|---|---|---|---|---|---|---|---|---|---|
| | | Example | Example | Example | Example | Example | Example | ple | ple | ple | ple |
| | Unit | 1 | 2 | 3 | 4 | 5 | 6 | 1 | 2 | 3 | 4 |
| Expanded graphite | wt % | 0 | 50 | 27 | 44 | 33 | 65 | 40 | 30 | 65 | 65 |
| Artificial graphite | | 60 | 25 | 13 | 23 | 17 | — | 20 | 30 | — | — |
| Carbon fibers | | 10 | 10 | 10 | 3 | 20 | 5 | 10 | 10 | 5 | 5 |
| Epoxy resin | | 25 | 12.5 | 42 | 25 | 25 | 15 | 25 | 25 | 27 | 21 |
| Polyimide resin | | 5 | 2.5 | 8 | 5 | 5 | — | 5 | 5 | — | — |
| Carboxyl-containing | | — | — | — | — | — | 15 | — | — | 3 | 9 |
| rubber | | | | | | | | | | | |
| Flexural strength | MPa | 73 | 25 | 55 | 28 | 50 | 28 | 42 | 49 | 40 | 36 |
| Modulus in flexure | GPa | 10 | 5 | 15 | 8 | 10 | 4 | 8 | 9 | 6.4 | 6 |
| Deflection at break | mm | 2.6 | 0.8 | 1.5 | 1.2 | 2.5 | 3 | 1.6 | 1.5 | 2.2 | 2.5 |
| Resistance | mΩ · cm² | 40 | 12 | 50 | 16 | 45 | 16 | 16 | 23 | 14 | 15 |

While the present invention has been described in detail and with reference to specific embodiments thereof, it will be apparent to one skilled in the art that various changes and modifications can be made therein without departing from the spirit and scope thereof.

This application is based on Japanese Patent Application No. 2005-77134 filed on Mar. 17, 2005, the contents thereof being herein incorporated by reference.

What is claimed is:

1. A separator for fuel cells, comprising:
a conductive filler comprising expanded graphite;
a binder; and
carbon fibers, wherein the separator has a deflection in flexure at break of 1 mm or larger, a modulus in flexure of 10 GPa or lower, and a flexural strength of 30 MPa or higher, each as examined at 100° C.

2. The separator for fuel cells of claim 1, wherein the conductive filler further comprises an artificial graphite in a proportion of up to 100 parts by weight per 100 parts by weight of the expanded graphite.

3. The separator for fuel cells of claim 2, wherein the artificial graphite has an average particle diameter which is not larger than 75% of the thickness of the thinnest part of the separator for fuel cells.

4. The separator for fuel cells of claim 1, wherein the binder comprises at least one member selected from the group consisting of an epoxy resin, a polyimide resin, and a functional-group-containing acrylonitrile/butadiene rubber.

5. The separator for fuel cells of claim 4, wherein the binder comprises up to 50 parts by weight of a functional-group-containing acrylonitrile/butadiene rubber per 100 parts by weight of an epoxy resin.

6. The separator for fuel cells of claim 1, wherein the content of the conductive filler is 50 to 70% by weight, the content of the binder is 20 to 40% by weight, and the content of the carbon fibers is 5 to 10% by weight.
